(19) United States
(12) Patent Application Publication
(10) Pub. No.: US 2022/0374611 A1
(43) Pub. Date: Nov. 24, 2022

(54) SPLIT KEYBOARD WITH DIFFERENT LANGUAGES AS INPUT

(71) Applicant: Citrix Systems, Inc., Fort Lauderdale, FL (US)

(72) Inventor: Hao Wu, Nanjing (CN)

(21) Appl. No.: 17/349,990

(22) Filed: Jun. 17, 2021

Related U.S. Application Data
(63) Continuation of application No. PCT/CN2021/094366, filed on May 18, 2021.

(51) Int. Cl. G06F 40/40; G06F 3/0488

(52) U.S. Cl. CPC G06F 40/40; G06F 3/04886

(57) ABSTRACT

Techniques for providing a split keyboard on an electronic device with different languages as input. The techniques include providing a first virtual keyboard and first input method editor (IME) configured in a first language on the electronic device, detecting or identifying, from the first virtual keyboard by the first IME, a character input string of a second language different from the first language, and, in response to detecting or identifying the character input string of the second language, providing a second virtual keyboard and second IME configured in the second language, displaying the second virtual keyboard alongside the first virtual keyboard on the electronic device, and offloading processing of the character input string of the second language from the first IME to the second IME. In this way, user experience while providing characters of different languages on an electronic device can be facilitated and improved.

### BACKGROUND

Electronic devices such as smartphones and tablet computers employ virtual keyboards for receiving alphanumeric and/or symbolic character input from users. The virtual keyboards are displayed and utilized on touchscreens of the devices and are accessed through applications executing on the devices. To launch a virtual keyboard on an electronic device, a user clicks on an application input field displayed on the device's touchscreen using his or her finger or thumb or a stylus. In response to the click, a virtual keyboard is launched and displayed on the touchscreen, allowing the user to provide, by touching selected keys on the virtual keyboard, alphanumeric and/or symbolic character input within the application input field. To facilitate thumb typing, the virtual keyboard may be displayed on the touchscreen as a split keyboard including a right panel of keys and a left panel of keys, in which each panel of keys is configured and arranged according to a thumb range of the user.

### SUMMARY

Virtual keyboards employed in electronic devices (e.g., smartphones, tablet computers) can be configured to accommodate English character input or non-English (e.g., Chinese, Japanese, Korean, French, German, and so on) character input. To receive English or non-English character input via a virtual keyboard, an electronic device can execute an input method editor (IME) application, which can be configured to process character input strings in an English language mode or non-English language mode. While processing character input strings in the English language mode, the IME application can generate and display, adjacent to the virtual keyboard, zero, one, or more suggestions (or predictions) of English words or characters (e.g., alphanumeric words/characters, symbolic words/characters) that a user can click on to facilitate and expedite his or her typing. Likewise, while processing character input strings in the non-English language mode, the IME application can generate and display, adjacent to the virtual keyboard, zero, one, or more suggestions (or predictions) of non-English words or characters (e.g., Chinese characters, Japanese characters, Korean characters, French characters, German characters, and so on) that the user can click on to facilitate and expedite his or her typing.

Such virtual keyboards configured to accommodate English character input or non-English character input have drawbacks, however, particularly if a user wishes to provide both English and non-English characters within the same application input field. For example, an electronic device may initially be configured to execute an IME application in the English language mode, allowing the user to provide, via a virtual keyboard, English words or characters within an application input field. Further, if the user wishes to provide non-English words/characters within the application input field in addition to the English words/characters, he or she may touch a specified key or key sequence on the virtual keyboard (or provide any other suitable control input) to switch the language mode of the IME application from English to non-English. Having switched the IME application from the English language mode to the non-English language mode, the user can provide, via the virtual keyboard, non-English words/characters within the application input field. If the user wishes to resume providing English words/characters within the application input field, he or she may again touch the specified key or key sequence on the virtual keyboard (or provide any other suitable control input) to switch the language mode of the IME application from non-English back to English. However, requiring the user to switch between language modes of the IME application multiple times to provide English and non-English words/characters within an application input field can be time-consuming and inconvenient if not confusing, and ultimately hamper user experience. For example, repetitive switching back and forth between language modes can cause users to lose their train of thought regarding what they wish to communicate via their electronic devices. Switching back and forth between language modes can also involve multiple steps, selections, and/or navigations to or through various menus to switch from one language to another different language.

Techniques are disclosed herein for providing a split keyboard on an electronic device with different languages as input. The disclosed techniques can be employed in electronic devices such as smartphones, tablet computers, and so on, to facilitate and improve user experience while providing two different manners of inputs (e.g., English and non-English character inputs) to the electronic devices. The disclosed techniques can include, in response to a user clicking on an application input field of an electronic device, launching an English virtual keyboard and input method editor (IME), and displaying the English virtual keyboard as a single keyboard on a touchscreen of the electronic device. The disclosed techniques can further include, in response to the user touching (e.g., with his or her finger or thumb or a stylus) selected keys on the English virtual keyboard that correspond to an English character input string, processing, by the English IME, the English character input string, including generating information for rendering the English characters and displaying, within the application input field, English alphanumeric and/or symbolic characters based on the rendering information. The disclosed techniques can further include, in response to the user touching selected keys on the English virtual keyboard that correspond to a character input string of a different language (e.g., a Pinyin character input string), detecting or identifying, by the English IME, the Pinyin character input string. The disclosed techniques can further include, in response to detecting or identifying the Pinyin character input string, launching a non-English (e.g., Chinese) virtual keyboard and IME, displaying the Chinese virtual keyboard alongside the English virtual keyboard on the touchscreen of the electronic device, and automatically offloading processing of the Pinyin character input string from the English IME to the Chinese IME. For example, such processing automatically offloaded to the Chinese IME can involve generating and displaying, on the touchscreen of the electronic device, one or more Chinese character suggestions (or predictions) for the Pinyin character input string.

By providing a first virtual keyboard and first IME conforming to a first language on an electronic device, detecting or identifying, from the first virtual keyboard by the first IME, a character input of a second language different from the first language, and, in response to detecting or identifying the character input of the second language, launching a second virtual keyboard and second IME conforming to the second language, displaying the second virtual keyboard alongside the first virtual keyboard on the electronic device, and automatically offloading processing of the character input of the second language from the first IME to the second IME, characters of different languages (e.g., Chinese, Japanese, Korean, French, German, and so on) can be provided on an electronic device in a manner that improves user experience.

In certain embodiments, a method includes providing a first virtual keyboard and a first input method editor (IME) on an electronic device, in which the first virtual keyboard is configured in a first language, and the first IME is configured to process input in the first language received at the first virtual keyboard. The method further includes detecting, by the first IME, an input received at the first virtual keyboard, in which the input has a translation in a second language different from the first language. The method further includes, in response to detecting the input, providing a second virtual keyboard and a second IME on the electronic device, in which the second virtual keyboard is configured in the second language, and the second IME is configured to process input in the second language received at least at the second virtual keyboard. The method further includes processing the detected input with use of the second IME so as to display the translation of the detected input with use of the second virtual keyboard.

In certain arrangements, the method further includes receiving, at the first virtual keyboard, an input in the first language, and displaying one or more first characters corresponding to the input in the first language within an application input field of the electronic device.

In certain arrangements, the method further includes displaying, along with the one or more first characters corresponding to the input in the first language, one or more second characters corresponding to the input having the translation in the second language within the application input field of the electronic device.

In certain arrangements, the method further includes providing a shared character input area for the first virtual keyboard and the second virtual keyboard, in which the shared character input area is configured to receive the one or more first characters and the one or more second characters prior to the respective first and second characters being sent for display within the application input field.

In certain arrangements, the method further includes generating, by the second IME, one or more character suggestions corresponding to the input having the translation in the second language, and displaying the one or more character suggestions on the electronic device.

In certain arrangements, the method further includes detecting a predetermined input from at least one of the first virtual keyboard and the second virtual keyboard, and, in response to detecting the predetermined input, removing one of the first virtual keyboard and the second virtual keyboard on the electronic device.

In certain arrangements, the method further includes monitoring, by the first IME, first input from the first virtual keyboard, and monitoring, by the second IME, second input from the second virtual keyboard, in which a total monitored input corresponds to an aggregate amount of the monitored first input and the monitored second input.

In certain arrangements, the method further includes determining that a percentage of the total monitored input is derived from a respective one of the first virtual keyboard and the second virtual keyboard, and removing, on the electronic device, a remaining one of the first virtual keyboard and the second virtual keyboard from which the percentage of the total monitored input was not derived.

In certain arrangements, the method further includes detecting a specified number of selections between a first layout of the first virtual keyboard and a second layout of the second virtual keyboard, and providing the second virtual keyboard and the second IME on the electronic device in response to detecting the specified number of selections.

In certain arrangements, the method further includes presenting, on the electronic device to a user, a dialog box configured to allow the user to make an affirmative selection as to whether or not to provide the second virtual keyboard and the second IME on the electronic device.

In certain embodiments, an electronic device includes a display, a memory, and processing circuitry configured to execute program instructions out of the memory to provide, on the display, a first virtual keyboard configured in a first language, in which a first input method editor (IME) is configured to process input in the first language received at the first virtual keyboard. The processing circuitry is further configured to execute the program instructions out of the memory to detect, by the first IME, an input received at the first virtual keyboard, in which the input has a translation in a second language different from the first language. The processing circuitry is further configured to execute the program instructions out of the memory, in response to detection of the input, to provide, on the display, a second virtual keyboard configured in the second language, in which a second IME is configured to process input in the second language received at least at the second virtual keyboard. The processing circuitry is further configured to execute the program instructions out of the memory to process the detected input with use of the second IME so as to display the translation of the detected input with use of the second virtual keyboard.

In certain arrangements, the processing circuitry is further configured to execute the program instructions out of the memory to receive, at the first virtual keyboard, an input in the first language, and display, on the display, one or more first characters corresponding to the input in the first language within an application input field of the electronic device.

In certain arrangements, the processing circuitry is further configured to execute the program instructions out of the memory to display, on the display along with the one or more first characters corresponding to the input in the first language, one or more second characters corresponding to the input having the translation in the second language within the application input field of the electronic device.

In certain arrangements, the processing circuitry is further configured to execute the program instructions out of the memory to provide a shared character input area for the first virtual keyboard and the second virtual keyboard, the shared character input area being configured to receive the one or more first characters and the one or more second characters prior to the respective first and second characters being sent for display within the application input field.

In certain arrangements, the processing circuitry is further configured to execute the program instructions out of the memory to generate, by the second IME, one or more character suggestions corresponding to the input having the translation in the second language, and display the one or more character suggestions on the display.

In certain arrangements, the processing circuitry is further configured to execute the program instructions out of the memory to detect a predetermined input from at least one of the first virtual keyboard and the second virtual keyboard, and, in response to detection of the predetermined input, remove, from the display, one of the first virtual keyboard and the second virtual keyboard.

In certain arrangements, the processing circuitry is further configured to execute the program instructions out of the memory to monitor, by the first IME, first input from the first virtual keyboard, and monitor, by the second IME, second input from the second virtual keyboard, wherein a total monitored input corresponds to an aggregate amount of the monitored first input and the monitored second input.

In certain arrangements, the processing circuitry is further configured to execute the program instructions out of the memory to determine that a percentage of the total monitored input is derived from a respective one of the first virtual keyboard and the second virtual keyboard, and remove, from the display, a remaining one of the first virtual keyboard and the second virtual keyboard from which the percentage of the total monitored input was not derived.

In certain arrangements, the processing circuitry is further configured to execute the program instructions out of the memory to detect a specified number of selections between a first layout of the first virtual keyboard and a second layout of the second virtual keyboard, and provide the second virtual keyboard and the second IME on the electronic device in response to detecting the specified number of selections.

In certain embodiments, a computer program product includes a set of non-transitory, computer-readable media having instructions that, when executed by processing circuitry, cause the processing circuitry to perform a method including providing a first virtual keyboard and a first input method editor (IME) on an electronic device, in which the first virtual keyboard is configured in a first language, and the first IME is configured to process input in the first language received at the first virtual keyboard. The method further includes detecting, by the first IME, an input received at the first virtual keyboard, in which the input has a translation in a second language different from the first language. The method further includes, in response to detecting the input, providing a second virtual keyboard and a second IME on the electronic device, in which the second virtual keyboard is configured in the second language, and the second IME is configured to process input in the second language received at least at the second virtual keyboard. The method further includes processing the detected input with use of the second IME so as to display the translation of the detected input with use of the second virtual keyboard.

Other features, functions, and aspects of the present disclosure will be evident from the Detailed Description that follows.

### BRIEF DESCRIPTION OF THE DRAWINGS

The foregoing and other objects, features, and advantages will be apparent from the following description of particular embodiments of the present disclosure, as illustrated in the accompanying drawings, in which like reference characters refer to the same parts throughout the different views.

FIG. 1a is a block diagram illustrating an exemplary network environment, in which techniques can be practiced for providing a split keyboard on an electronic device with different languages as input;

FIG. 1b is a block diagram of an exemplary input method editor (IME) of a first language and an exemplary IME of a second language that can be launched on the electronic device of FIG. 1a;

FIG. 2a is a diagram of an exemplary electronic device having a touchscreen, an application input field, and an English virtual keyboard displayed on the touchscreen, in which the English virtual keyboard is displayed on the touchscreen as a single keyboard, and a Pinyin character input string is displayed within the application input field;

FIG. 2b is a diagram of the electronic device of FIG. 2a, in which a Chinese keypad is displayed alongside an English keypad on the touchscreen, and a Pinyin character input string and corresponding Chinese characters are displayed in the application input field;

FIG. 2c is a diagram of the electronic device of FIG. 2b, in which English characters/words and another Pinyin character input string and corresponding Chinese character are displayed in the application input field in addition to the Pinyin character input string and corresponding Chinese characters of FIG. 2b;

FIG. 3 is a flow diagram illustrating an exemplary method of providing a split keyboard on an electronic device with different languages as input;

FIG. 4 is a diagram of an exemplary electronic device, in which an English keypad and a Chinese keypad each have an associated character/word suggestion field and an associated character/word input area; and

FIG. 5 is a diagram of another exemplary electronic device, in which an English keypad and a Chinese keypad each have an associated character/word suggestion field and share a single character/word input area.

### DETAILED DESCRIPTION

Techniques are disclosed herein for providing a split keyboard on an electronic device with different languages as input. The disclosed techniques can include providing a first virtual keyboard and first input method editor (IME) conforming to a first language on the electronic device, detecting or identifying, from the first virtual keyboard by the first IME, a character input of a second language different from the first language, and, in response to detecting or identifying the character input of the second language, launching a second virtual keyboard and second IME conforming to the second language, displaying the second virtual keyboard alongside the first virtual keyboard on the electronic device, and automatically offloading processing of the character input of the second language from the first IME to the second IME. Such processing automatically offloaded to the second IME can involve generating and displaying, on the electronic device, one or more character suggestions (or predictions) for the character input of the second language. In this way, user experience can be improved while providing characters of different languages on an electronic device. For example, repetitive switching back and forth between language modes, which can cause users to lose their train of thought regarding what they wish to communicate via their electronic devices, can be avoided.

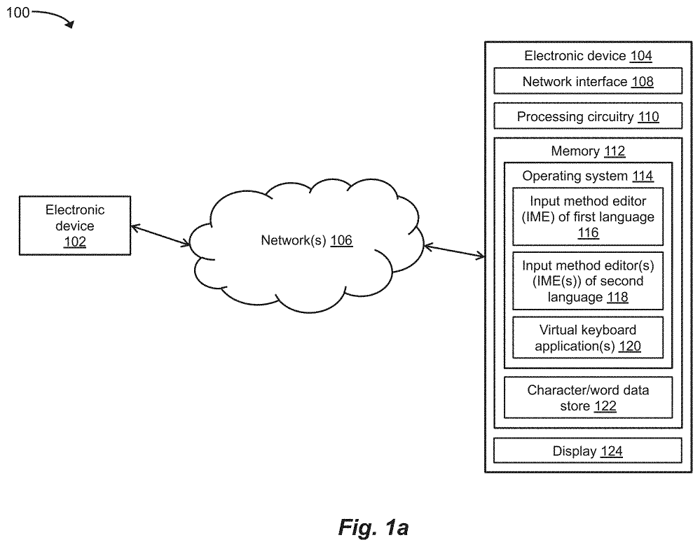

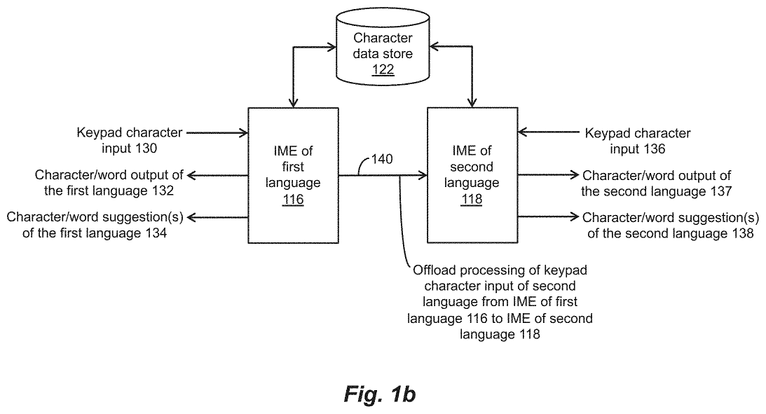

FIG. 1a depicts an illustrative embodiment of an exemplary network environment 100 for providing a split keyboard on an electronic device with different languages as input. As shown in FIG. 1, the network environment 100 can include one or more electronic devices 102, 104 such as smartphones, tablet computers, and/or any other suitable electronic devices, and one or more networks 106. The network(s) 106 can include one or more wired and/or wireless networks such as local area network(s) (LAN(s)), metropolitan area network(s) (MAN(s)), wide area network(s) (WAN(s)), cellular networks, the Internet, and/or any other suitable network(s). The electronic device 104 can be configured to include a network interface 108, processing circuitry 110, a memory 112, and a display 124. It is noted that the electronic device 102 can be configured like the electronic device 104. The network interface 108 can be configured to communicably connect the electronic device 104 to the electronic device 102 (or any other suitable electronic device, mobile phone, computer, or computerized device) via the network(s) 106. The memory 112 can be configured to include volatile storage (e.g., random-access memory (RAM)) and/or non-volatile storage (e.g., read-only memory (ROM), flash memory), which can include a character/word data store 122. The memory 112 can be further configured to store a variety of software constructs, including an operating system (OS) 114 such as an Android OS, iPhone OS (iOS), Linux OS, Unix OS, Windows OS, or any other suitable OS, and one or more application programs that can be executed on the OS 114. The application programs can include an input method editor (IME) of a first language 116, at least one IME of a second language 118, and two or more virtual keyboard applications 120. Such software constructs can be realized in the form of specialized code and data (e.g., program instructions), which can be executed by the processing circuitry 110 to carry out the techniques and/or methods disclosed herein. The processing circuitry 110 can include one or more processors, controllers, IO modules, user input modules, and so on, or any suitable combination thereof. The display 124 can include a touchscreen visual display, a non-touchscreen visual display, or any other suitable visual display capable of displaying alphanumeric characters, symbolic characters, Chinese characters, Japanese characters, Korean characters, French characters, German characters, graphics, and so on, to a user.

FIG. 1B depicts representations of the IME of the first language 116 and the IME of the second language 118, each of which can be executed by the processing circuitry 110 of the electronic device 104. As employed herein, the term “IME of a first language” refers to an input method editor configured to operate in a first language mode (e.g., Chinese, Japanese, Korean, French, German, and so on), and the term “IME of a second language” refers to an input method editor configured to operate in a second language mode different from the first language mode. The FIG. 1b further depicts the character/word data store 122, which can contain character/word entries of the first language, as well as character/word entries of at least the second language. As shown in FIG. 1b, the IME of the second language 118 can be configured to receive a keypad character input 136 (such as from a virtual keypad of the second language), and map the keypad character input 136 to one or more character/word entries of the second language in the character/word data store 122. Further, the IME of the second language 118 can pass a corresponding character/word output of the second language 137 to the OS 114 for transfer to the application executing on the electronic device 104, as well as provide one or more character/word suggestions of the second language 138 to the display 124, which can display the character/word suggestions (or predictions) 138 to the user.

In one embodiment, the IME 118 can be a Chinese IME, receive a Pinyin character input from a Chinese virtual keypad, and generate one or more Chinese characters that correspond to the Pinyin character input. Further, if the Pinyin character input can correspond to one or more possible Chinese characters, the IME 118 can provide one or more Chinese character suggestions to the display 124, which can display the Chinese character suggestions (or predictions) to a user. The user can click on or otherwise select his or her intended Chinese character(s) from the Chinese character suggestions (or predictions) on the display 124, as desired, and the IME 118 can pass the selected Chinese character(s) to the OS 114 for transfer to an application executing on the electronic device 104.

As further shown in FIG. 1B, the IME of the first language 116 can be configured to receive a keypad character input 130, and map the keypad character input 130 to one or more character/word entries of the first language in the character/word data store 122. Having received and mapped the keypad character input 130, the IME of the first language 116 can pass a corresponding character/word output of the first language 132 to the OS 114 for transfer to the application executing on the electronic device 104, as well as provide one or more character/word suggestions of the first language 134 to the display 124, which can display the character/word suggestions (or predictions) 134 to the user. The user can click on or otherwise select his or her intended character/word of the first language on the display 124, as desired, and the IME of the first language 116 can pass the selected character/word to the OS 114 for transfer to the application executing on the electronic device 104.

In one embodiment, the IME 116 can be an English IME and receive a Pinyin (or other non-English) character input from an English virtual keypad. In response to mapping the Pinyin character input to character/word entries in the character/word data store 122, the IME 116 can detect or identify the received character input as corresponding to the Pinyin language. Further, having detected or identified the character input as corresponding to the Pinyin language, the ME 116 can automatically offload processing of the Pinyin character input to the IME 118, as represented by a path 140. The IME 118 can receive the Pinyin character input from the IME 116, and perform the processing of the Pinyin character input, including generating one or more Chinese characters that correspond to the Pinyin character input and providing one or more Chinese character suggestions to the display 124, which can display the Chinese character suggestions (or predictions) to the user. The user can click on or otherwise select his or her intended Chinese character(s) on the display 124, and the IME 118 can pass the selected Chinese character(s) to the OS 114 for transfer to the application executing on the electronic device 104.

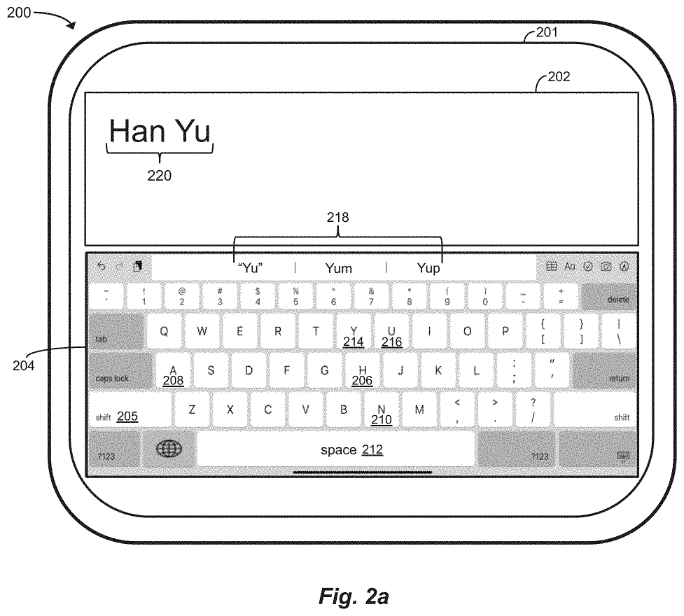

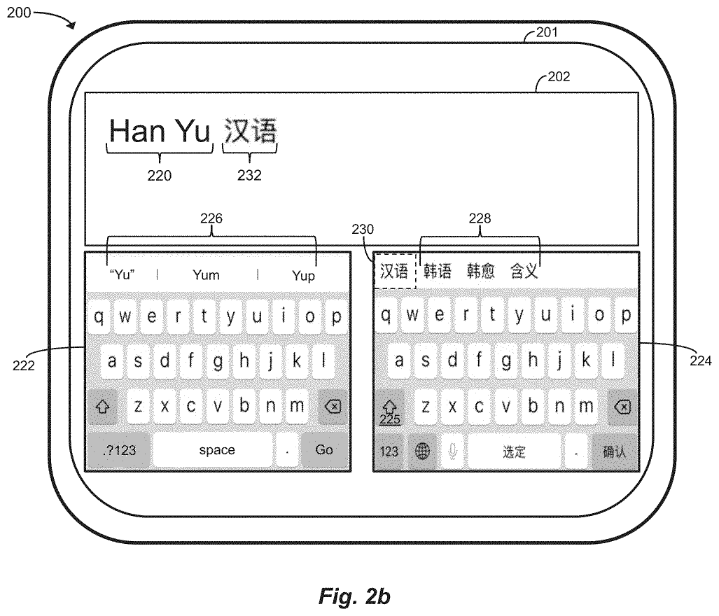

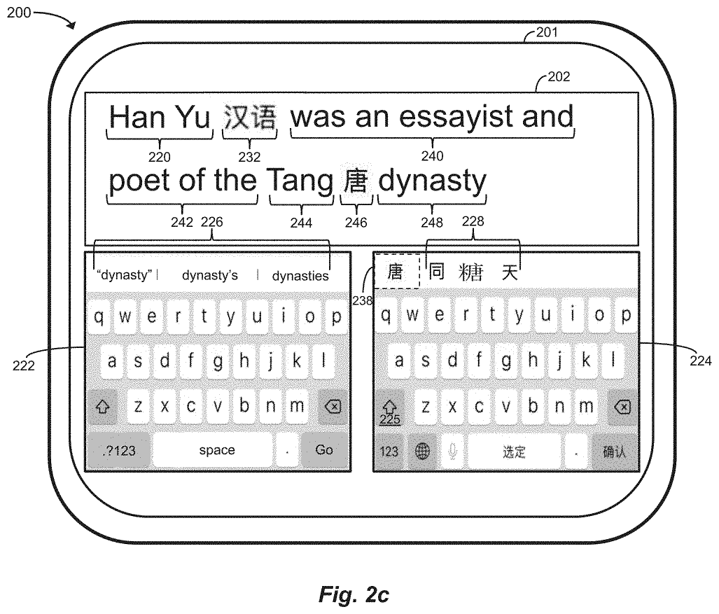

The disclosed techniques for providing a split keyboard on an electronic device with different languages as input will be further understood with reference to the following illustrative example and FIGS. 2a-2c. In this example, it is assumed that the disclosed techniques are implemented on an electronic device 200 such as a smartphone or tablet computer. Moreover, it is assumed that the electronic device 200 is configured to execute an English IME (e.g., the IME 116; see FIGS. 1a and 1b), a Chinese IME (e.g., the IME 118; see FIGS. 1a and 1b), and an application program (e.g., a text message application program, an email application program, a notes application program) operative to receive English character/word output and word suggestions generated by the English IME, as well as Chinese character suggestions generated by the Chinese IME.

FIG. 2a depicts an exemplary electronic device 200 employed in this example. As shown in FIG. 2a, the electronic device 200 has a touchscreen visual display (also referred to herein as the “touchscreen”) 201. Upon execution of the application program, an application input field 202 is displayed on the touchscreen 201. In this example, a user touches, clicks on, or otherwise selects (e.g., with his or her finger or thumb or a stylus) the application input field 202, causing a virtual English keyboard (also referred to herein as the “English keyboard”) 204 to be launched and displayed on the touchscreen 201. The English keyboard 204 can be either a full keyboard or a partial keyboard, depending on a given use case. Further, the user touches, on the English keyboard 204, a key sequence that includes a key 205 (shift), a key 206 (“H”), a key 208 (“a”), a key 210 (“n”), a key 212 (space), the key 205 (shift), a key 214 (“Y”), and a key 216 (“u”). In response to touching the sequence of keys 205, 206, 208, 210, 212, 205, 214, and 216, English characters representing the name “Han Yu” 220 are generated by the English IME and displayed within the application input field 202. It is noted that, in response to touching the key 205 (shift), the key 214 (“Y”), and the key 216 (“u”), several English word suggestions are provided within a suggestion field 218 of the English keyboard 204, namely, the English words “Yum” and “Yup.” Also provided within the suggestion field 218 are the English characters “Yu,” which mirror or repeat the characters “Y” and “u” displayed within the application input field 202. The user can click on or otherwise select one of these English character/word suggestions within the suggestion field 218 to facilitate and expedite his or her typing, as desired.

In this example, the English IME maps the keypad character input “Han Yu” 220 to character/word entries in the character/word data store 122, and, in response to the mapping, detects or identifies the keyboard character input “Han Yu” 220 as a Pinyin character input. As employed herein, the term “Pinyin” refers to the official romanization system for standard Mandarin Chinese used in China. In other use cases, the user can select the virtual keyboard 204 (e.g., by selecting a portion of the virtual keyboard 204 without any keys and holding a predefined key) and perform a gesture (e.g., a reverse pinch gesture over the virtual keyboard 204 or another area of the display 201) to present multiple keyboards. In response to detecting or identifying the keyboard character input “Han Yu” 220 as a Pinyin character input (or other input indicative of a desire to display multiple keyboards), a virtual English keyboard of reduced size and/or content (also referred to herein as the “English keypad”) 222 (see FIG. 2b) is launched and displayed on the touchscreen 201 in place of the English keyboard 204, and a virtual Chinese keyboard (also referred to herein as the “Chinese keypad”) 224 (see FIG. 2b) is launched and displayed on the touchscreen 201 alongside the English keypad 222. The Chinese keypad 224 can also be a partial keyboard of reduced sized, depending on a given use case. As employed herein, a virtual “keypad” can have a reduced number of keys in relation to a corresponding virtual “keyboard” in order to facilitate display of two virtual keypads alongside each other on a touchscreen of an electronic device. The English IME (which operates in conjunction with the English keypad 222) automatically offloads processing of the Pinyin character input “Han Yu” 220 to the Chinese IME (which operates in conjunction with the Chinese keypad 224). Like the English keyboard 204 (see FIG. 2a), the English keypad 222 has a suggestion field 226 with the English words “Yum” and “Yup” and the English characters “Yu,” which were initially provided in response to the user touching the key 205 (shift), the key 214 (“Y”), and the key 216 (“u”) on the English keyboard 204. The Chinese keypad 224 also has a suggestion field 228, which, in response to processing the Pinyin character input “Han Yu” 220, provides several groups of Chinese characters that may possibly correspond to the Pinyin character input “Han Yu.” The user clicks on or otherwise selects a group of Chinese characters denoted by reference numeral 230 (see FIG. 2b) within the suggestion field 228, causing corresponding Chinese characters denoted by reference numeral 232 (see FIG. 2b) to be generated by the Chinese IME and displayed within the application input field 202.

Now that the Chinese keypad 224 is displayed on the touchscreen 201 alongside the English keypad 222, the user can touch selected keys on the English keypad 222 to generate and display English characters/words within the application input field 202, as well as touch selected keys on the Chinese keypad 224 to generate and display Chinese characters within the application input field 202, without having to switch multiple times between English and Chinese language modes of an IME application. In this example, the user touches selected keys on the English keypad 222 to generate and display the English words “was an essayist and” (reference numeral 240; see FIG. 2c) and “poet of the” (reference numeral 242; see FIG. 2c) within the application input field 202. The user also touches selected keys on the English keypad 222 to generate and display the English characters representing the name “Tang” 244 (see FIG. 2c). The English IME maps the keypad character input “Tang” 244 to character/word entries in the character/word data store 122, detects or identifies the keypad character input “Tang” 244 as a Pinyin character input in response to the mapping, and automatically offloads processing of the Pinyin character input “Tang” 244 to the Chinese IME. In response to processing the Pinyin character input “Tang” 244, the suggestion field 228 of the Chinese keypad 224 provides several Chinese characters that may possibly correspond to the Pinyin character input “Tang.” The user clicks on or otherwise selects a Chinese character denoted by reference numeral 238 (see FIG. 2c) within the suggestion field 228, causing a corresponding Chinese character denoted by reference numeral 246 (see FIG. 2c) to be generated by the Chinese IME and displayed within the application input field 202. It is noted that the user can alternatively touch keys “⬆” (shift; reference numeral 225), “t,” “a,” “n,” and “g” on the Chinese keypad 224 to provide, within the suggestion field 228, the several Chinese characters possibly corresponding to the Pinyin character input “Tang.”

Having clicked on or otherwise selected the Chinese character denoted by reference numeral 238 (see FIG. 2c) within the suggestion field 228, the user touches selected keys on the English keypad 222 to generate and display the English word “dynasty” (reference numeral 248; see FIG. 2c) within the application input field 202. It is noted that, in response to touching the keys to generate and display the English word “dynasty” 248, several English word suggestions are provided within the suggestion field 226 of the English keypad 222, namely, the English words “dynasty's” and “dynasties.” Also provided within the suggestion field 226 are the English characters “dynasty,” which mirror or repeat the characters “d,” “y,” “n,” “a,” “s,” “t,” and “y” (reference numeral 248; see FIG. 2c) displayed within the application input field 202. The user can click on or otherwise select one of these English character/word suggestions within the suggestion field 226 to facilitate and expedite his or her typing, as desired.

Finally in this example, the user restores the touchscreen 201 to display only the English keyboard 204 by touching, on at least one of the English and Chinese keypads 222, 224, a specified key for a predetermined length of time or a specified key sequence, or by providing any other suitable control input. In response to touching the specified key for the predetermined length of time or the specified key sequence, the English keypad 222 and the Chinese keypad 224 are automatically removed from the touchscreen 201, and the English keyboard 204 is relaunched and displayed on the touchscreen. The user can then touch selected keys on the

English keyboard 204 to generate and display additional English characters/words within the application input field 202, as desired. If, however, the user touches selected keys on the English keyboard 204 that the English IME detects or identifies as corresponding to a Pinyin character input, then the English keypad 222 will be relaunched and displayed on the touchscreen 201 in place of the English keyboard 204, and the Chinese keypad 224 will be relaunched and displayed on the touchscreen 201 alongside the English keypad 222.

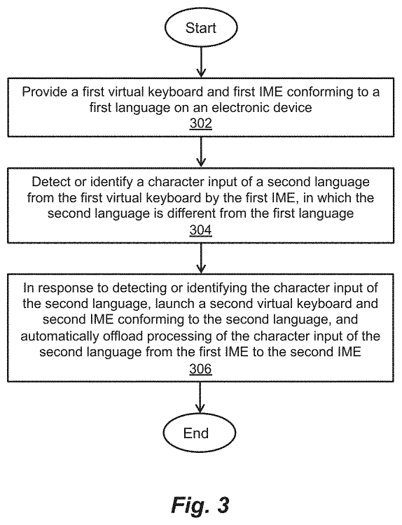

An exemplary method of providing a split keyboard on an electronic device with different languages as input is described below with reference to FIG. 3. As depicted in block 302, a first virtual keyboard and first IME are provided conforming to (or otherwise configured in) a first language on an electronic device. As depicted in block 304, a character input of a second language is detected or identified from the first virtual keyboard by the first IME, in which the second language is different from the first language. As depicted in block 306, in response to detecting or identifying the character input of the second language, a second virtual keyboard and second IME are launched conforming to the second language, and processing of the character input of the second language is automatically offloaded from the first IME to the second IME. In this way, characters of different languages can be provided on an electronic device in a manner that improves user experience.

Having described the foregoing illustrative embodiments, other alternative embodiments and/or variations may be made and/or practiced. For example, it was described herein that a user can restore a touchscreen on an electronic device (e.g., smartphone, tablet computer) to display a single virtual keyboard by touching (or otherwise providing an input), on a first virtual (e.g., English) keypad and/or a second virtual (e.g., Chinese) keypad of a split keyboard configuration, a specified key for a predetermined length of time or a specified key sequence. In other use cases, the user can employ a swipe or other gesture to remove one keyboard/keypad from the display and therefore allow display of a single keyboard/keypad. The resulting keyboard/keypad can be in the form of the keyboard/keypad removed by the swipe gesture. Alternatively, the keyboard/keypad that remains on the display after such a gesture can be enlarged and/or reconfigured (e.g., provided with full or additional content). In still other use cases, the user can perform a merge gesture (e.g., a pinch gesture to move both keyboards/keypads into one another so as to merge them together) and cause display of a previous version of a keyboard/keypad (e.g., the keyboard 204; see FIG. 2a) similar to that shown before launch, activation, or invocation of multiple keyboards/keypads.

In an alternative embodiment, a touchscreen of an electronic device can be automatically restored to display a single virtual keyboard by continuously monitoring keypad character input provided by each of the first virtual (e.g., English) keypad and the second virtual (e.g., Chinese) keypad. Further, for a predetermined number of character input events, if all (or a predetermined number or percentage) of the character input events are provided by a particular one of the virtual English and Chinese keypads, then the virtual English or Chinese keypad that did not provide any of the character input events can be automatically removed from the touchscreen, and the virtual Chinese or English keypad that provided all of the character input events can be relaunched and displayed as a single Chinese or English virtual keyboard.

It was also described herein that, in response to detecting or identifying a keyboard character input from a keyboard that conforms to a language different from the keyboard language, two virtual keypads conforming to the different languages can be launched and displayed on a touchscreen in a split keyboard configuration in place of the original keyboard. In one alternative embodiment, a user can cause such virtual keypads conforming to different languages to be launched and displayed in the split keyboard configuration by touching, on the original keyboard, a specified key for a predetermined length of time or a specified key sequence, or by providing any other suitable control input. In another alternative embodiment, keyboard layout software can be provided to detect changes in a keyboard locale, such as changes from an English (e.g., QWERTY) keyboard layout to a Chinese (e.g., Pinyin) keyboard layout. In response to such changes in the keyboard locale being detected a specified number of times, the two keypads conforming to the different languages (e.g., English, Chinese, and so on) can be launched and displayed on the touchscreen in the split keyboard configuration in place of the original keyboard. In this alternative embodiment, a dialog box can also be presented on the touchscreen to allow the user to make an affirmative selection regarding whether to launch/display or not launch/display the keypads in the split keyboard configuration.

It was also described herein that, in response to receipt of keypad character input from a user, character/word suggestions (or predictions) can be displayed on a touchscreen to the user. In an alternative embodiment, in addition to one or more character/word suggestion fields, one or more character/word input areas can be displayed on the touchscreen and employed while the user provides keyboard or keypad character input.

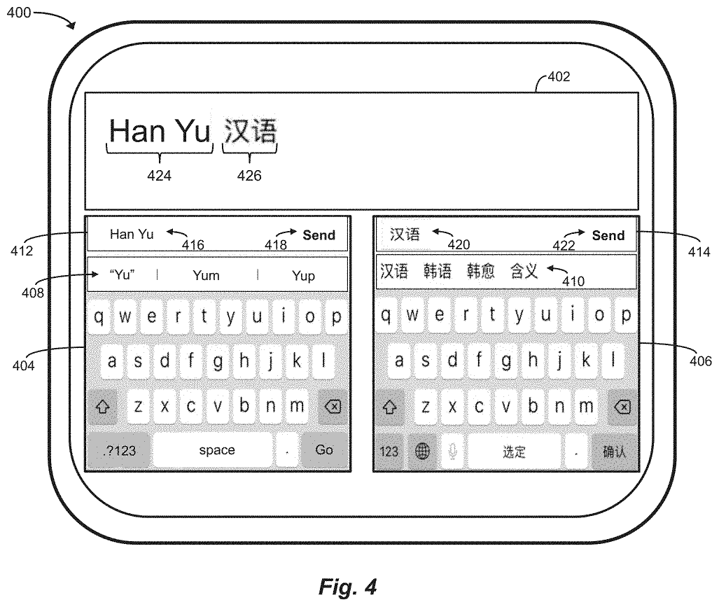

FIG. 4 depicts an exemplary electronic device (e.g., smartphone, tablet computer) 400 that employs a character/word suggestion field 408 and a character/word input area 412 in association with a first virtual (e.g., English) keypad 404, as well as a character/word suggestion field 410 and a character/word input area 414 in association with a second virtual (e.g., Chinese) keypad 406. In this alternative embodiment, a user can touch selected keys on the English keypad 404 to generate and display English characters representing the name “Han Yu” 416 within the character/word input area 412. Further, rather than immediately sending corresponding English characters to an application and displaying the English characters “Han Yu” within an application input field 402, the user can click on “Send” 418 within the character/word input area 412 to send and display the English characters “Han Yu” 424 within the application input field 402. Likewise, the user can touch selected keys on the Chinese keypad 406 to generate and display Chinese characters 420 representing the name “Han Yu” within the character/word input area 414. Further, rather than immediately sending corresponding Chinese characters to an application and displaying the Chinese characters within the application input field 402, the user can click on “Send” 422 within the character/word input area 414 to send and display the Chinese characters denoted by reference numeral 426 within the application input field 402. In one embodiment, the user can touch selected keys on the English keypad 404 to generate and display the English characters representing the name “Han Yu” 416 within the character/word input area 412, and further processing of the characters “Han Yu” can be offloaded from the IME of the English keypad 404 to the IME of the Chinese keypad 406 to cause the Chinese characters 420 representing the name “Han Yu” to be automatically generated and displayed within the character/word input area 414.

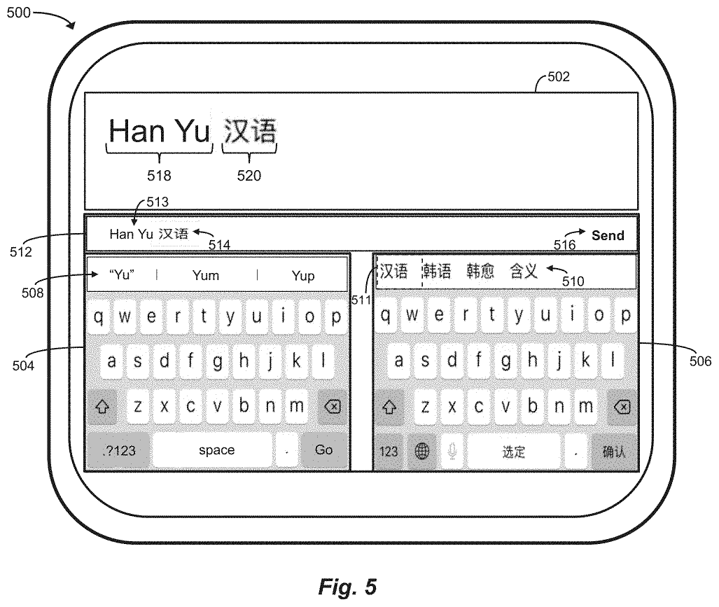

FIG. 5 depicts an exemplary electronic device (e.g., smartphone, tablet computer) 500 that employs a character/word suggestion field 508 in association with a first virtual (e.g., English) keypad 504, a character/word suggestion field 510 in association with a second virtual (e.g., Chinese) keypad 506, and a character/word input area 512 that can be shared between the English and Chinese keypads 504, 506. In this alternative embodiment, a user can touch selected keys on the English keypad 504 to generate and display English characters representing the name

“Han Yu” 513 within the shared character/word input area 512. The user can also touch selected keys on the Chinese keypad 506 to generate and display Chinese characters denoted by reference numeral 514 representing the name “Han Yu” within the shared character/word input area 512. The user can then click on “Send” 516 within the shared character/word input area 512 to send and display English characters “Han Yu” 518 and Chinese characters denoted by reference numeral 520 within an application input field 502.

It was also described herein that application programs executed on an operating system of an electronic device (e.g., smartphone, tablet computer) can include two or more IMEs of different languages, such as an English IME and at least one non-English IME. In an alternative embodiment, such an electronic device can be configured to execute an English IME and a plurality of non-English IMEs (e.g., Chinese, Japanese, Korean, and so on). Further, in response to detecting or identifying, from an English keypad by the English IME, a keypad character input representing phonetic sounds of the Chinese, Japanese, or Korean language, a virtual keypad and IME conforming to the Chinese, Japanese, or Korean language can be launched, and the virtual keypad can be displayed alongside the English keypad. In addition, processing of the keypad character input can be automatically offloaded from the English IME to the IME conforming to the Chinese, Japanese, or Korean language, as appropriate.

Although features have been described herein with reference to particular illustrative embodiments thereof, such features may be included in any of the disclosed embodiments and/or their variants. Thus, it is understood that features disclosed in connection with any embodiment are included as variants of any other embodiment. Further, the improvement or portions thereof may be embodied as a computer program product including one or more non-transient, computer-readable storage media, such as a magnetic disk, magnetic tape, compact disk (CD), digital versatile disk (DVD), optical disk, flash drive, solid state drive (SSD), secure digital (SD) chip or device, ASIC, FPGA, and/or the like. Any number of computer-readable media may be used. The media may be encoded with instructions that, when executed on one or more computers, processors, or processing circuitry, perform the process(es) or method(s) described herein. Such media may be considered as articles of manufacture or machines and may be transportable from one machine to another.

As used throughout this document, the terms “comprising,” “including,” “containing,” and “having” are intended to set forth certain items, steps, acts, elements, or aspects of something in an open-ended fashion. Also, as employed herein, the term “group” means one or more of something. This is the case regardless of whether the phrase “group of” is followed by a singular or plural object, or whether it is conjugated with a singular or plural verb. Further, although ordinal expressions, such as “first,” “second,” “third,” and so on, may be used as adjectives herein, such ordinal expressions are used for identification purposes, and, unless specifically indicated, are not intended to imply any ordering or sequence. Thus, for example, a “second event” may take place before or after a “first event,” or even if no first event ever occurs. In addition, an identification herein of a particular element, feature, or act as being a “first” such element, feature, or act should not be construed as requiring that there must also be a “second” or other such element, feature, or act. Rather, the “first” item may be the only one. Although certain illustrative embodiments are disclosed herein, it is understood that these embodiments are provided by way of example only, and that the disclosed systems, apparatus, methods, processes, and/or techniques are not limited to these particular embodiments.

While various embodiments of the disclosure have been particularly shown and described, it will be understood by those skilled in the art that various changes in form and details may be made therein without departing from the scope of the disclosure, as defined by the appended claims.

What is claimed is:

1. A method, comprising:
providing a first virtual keyboard and a first input method editor (IME) on an electronic device, the first virtual keyboard being configured in a first language, and the first IME being configured to process input in the first language received at the first virtual keyboard;
detecting, by the first IME, an input received at the first virtual keyboard, the input having a translation in a second language different from the first language;
in response to detecting the input, providing a second virtual keyboard and a second IME on the electronic device, the second virtual keyboard configured in the second language, and the second IME configured to process input in the second language received at least at the second virtual keyboard; and
processing the detected input with use of the second IME so as to display the translation of the detected input with use of the second virtual keyboard.

2. The method of claim 1 further comprising:
receiving, at the first virtual keyboard, an input in the first language; and
displaying one or more first characters corresponding to the input in the first language within an application input field of the electronic device.

3. The method of claim 2 further comprising:
displaying, along with the one or more first characters corresponding to the input in the first language, one or more second characters corresponding to the input having the translation in the second language within the application input field of the electronic device.

4. The method of claim 3 wherein providing the second virtual keyboard and the second IME on the electronic device includes providing a shared character input area for the first virtual keyboard and the second virtual keyboard, the shared character input area being configured to receive the one or more first characters and the one or more second characters prior to the respective first and second characters being sent for display within the application input field.

5. The method of claim 1 wherein processing the detected input includes generating, by the second IME, one or more character suggestions corresponding to the input having the translation in the second language, and displaying the one or more character suggestions on the electronic device.

6. The method of claim 1 further comprising:
detecting a predetermined input from at least one of the first virtual keyboard and the second virtual keyboard; and
in response to detecting the predetermined input, removing one of the first virtual keyboard and the second virtual keyboard on the electronic device.

7. The method of claim 1 further comprising:
monitoring, by the first IME, first input from the first virtual keyboard; and
monitoring, by the second IME, second input from the second virtual keyboard, a total monitored input corresponding to an aggregate amount of the monitored first input and the monitored second input.

8. The method of claim 7 further comprising:
determining that a percentage of the total monitored input is derived from a respective one of the first virtual keyboard and the second virtual keyboard; and
removing, on the electronic device, a remaining one of the first virtual keyboard and the second virtual keyboard from which the percentage of the total monitored input was not derived.

9. The method of claim 1 wherein providing the second virtual keyboard and the second IME on the electronic device includes detecting a specified number of selections between a first layout of the first virtual keyboard and a second layout of the second virtual keyboard, and providing the second virtual keyboard and the second IME on the electronic device in response to detecting the specified number of selections.

10. The method of claim 9 further comprising:
presenting, on the electronic device to a user, a dialog box configured to allow the user to make an affirmative selection as to whether or not to provide the second virtual keyboard and the second IME on the electronic device.

11. An electronic device, comprising:
a display;
a memory; and
processing circuitry configured to execute program instructions out of the memory to:
provide, on the display, a first virtual keyboard configured in a first language, wherein a first input method editor (IME) is configured to process input in the first language received at the first virtual keyboard;
detect, by the first IME, an input received at the first virtual keyboard, wherein the input has a translation in a second language different from the first language;
in response to detection of the input, provide, on the display, a second virtual keyboard configured in the second language, wherein a second IME is configured to process input in the second language received at least at the second virtual keyboard; and
process the detected input with use of the second IME so as to display the translation of the detected input with use of the second virtual keyboard.

12. The electronic device of claim 11 wherein the processing circuitry is further configured to execute the program instructions out of the memory to receive, at the first virtual keyboard, an input in the first language, and display, on the display, one or more first characters corresponding to the input in the first language within an application input field of the electronic device.

13. The electronic device of claim 12 wherein the processing circuitry is further configured to execute the program instructions out of the memory to display, on the display along with the one or more first characters corresponding to the input in the first language, one or more second characters corresponding to the input having the translation in the second language within the application input field of the electronic device.

14. The electronic device of claim 13 wherein the processing circuitry is further configured to execute the program instructions out of the memory to provide a shared character input area for the first virtual keyboard and the second virtual keyboard, the shared character input area being configured to receive the one or more first characters and the one or more second characters prior to the respective first and second characters being sent for display within the application input field.

15. The electronic device of claim 11 wherein the processing circuitry is further configured to execute the program instructions out of the memory to generate, by the second IME, one or more character suggestions corresponding to the input having the translation in the second language, and display the one or more character suggestions on the display.

16. The electronic device of claim 11 wherein the processing circuitry is further configured to execute the program instructions out of the memory to detect a predetermined input from at least one of the first virtual keyboard and the second virtual keyboard, and, in response to detection of the predetermined input, remove, from the display, one of the first virtual keyboard and the second virtual keyboard.

17. The electronic device of claim 11 wherein the processing circuitry is further configured to execute the program instructions out of the memory to monitor, by the first IME, first input from the first virtual keyboard, and monitor, by the second IME, second input from the second virtual keyboard, wherein a total monitored input corresponds to an aggregate amount of the monitored first input and the monitored second input.

18. The electronic device of claim 17 wherein the processing circuitry is further configured to execute the program instructions out of the memory to determine that a percentage of the total monitored input is derived from a respective one of the first virtual keyboard and the second virtual keyboard, and remove, from the display, a remaining one of the first virtual keyboard and the second virtual keyboard from which the percentage of the total monitored input was not derived.

19. The electronic device of claim 11 wherein the processing circuitry is further configured to execute the program instructions out of the memory to detect a specified number of selections between a first layout of the first virtual keyboard and a second layout of the second virtual keyboard, and provide the second virtual keyboard and the second IME on the electronic device in response to detecting the specified number of selections.

20. A computer program product including a set of non-transitory, computer-readable media having instructions that, when executed by processing circuitry, cause the processing circuitry to perform a method comprising:
providing a first virtual keyboard and a first input method editor (IME) on an electronic device, the first virtual keyboard being configured in a first language, and the first IME being configured to process input in the first language received at the first virtual keyboard;
detecting, by the first IME, an input received at the first virtual keyboard, the input having a translation in a second language different from the first language;
in response to detecting the input, providing a second virtual keyboard and a second IME on the electronic device, the second virtual keyboard configured in the second language, and the second IME configured to process input in the second language received at least at the second virtual keyboard; and
processing the detected input with use of the second IME so as to display the translation of the detected input with use of the second virtual keyboard.
